(19) United States
(12) Patent Application Publication
(10) Pub. No.: US 2023/0264212 A1
(43) Pub. Date: Aug. 24, 2023

(54) SPRAY GUN DEVICE AND SYSTEM FOR DISPENSING POLYURETHANE

(71) Applicant: BASF SE, Ludwigshafen am Rhein (DE)

(72) Inventors: John H. Swab, Central, SC (US); William J. Rowand, Phil Campbell, AL (US); Thomas Fredrick Smith, Central, SC (US)

(73) Assignee: BASF SE, Ludwigshafen am Rhein (DE)

(21) Appl. No.: 18/004,210

(22) PCT Filed: Jul. 6, 2021
(86) PCT No.: PCT/US2021/040487

§ 371 Date: Jan. 4, 2023

Related U.S. Application Data
(60) Provisional application No. 63/048,346, filed on Jul. 6, 2020.

(51) Int. Cl. B05B 7/16; B05B 7/00; B05B 12/08; B05B 12/00; B29B 7/72; B05B 7/04; B29B 7/74

(52) U.S. Cl. CPC B05B 7/1693; B05B 7/0031; B05B 12/085; B05B 12/002; B29B 7/726; B05B 7/0408; B29B 7/7447

(57) ABSTRACT

A foam dispensing apparatus and system thereof can be used for dispensing a mixture of a resin component and an isocyanate component. The foam dispensing apparatus contains a heated hose assembly, a spray gun containing a spray head and a mix tube, and a nozzle for dispensing the resin and isocyanate components from the spray gun. Components of the foam dispensing system are lightweight and/or low cost thereby facilitating use and maintenance.

### BACKGROUND OF THE INVENTION

### Field of the Invention

The subject invention generally relates to spray guns and related equipment for dispensing polyurethane foam and more particularly to systems for dispensing mixtures of a resin component and an isocyanate component.

### Description of the Related Art

Chemical foam compositions, such as polyurethane foams, are presently well known and used in a number of different applications. Polyurethane foams are useful in such applications as thermal insulation, marine floatation, coatings, and packaging. Polyurethane foams are formed by the mixture of a resin component and an isocyanate component.

In most polyurethane production systems, a resin component and an isocyanate component are separately stored in tanks until use. The resin and isocyanate components are mixed in a foam dispensing apparatus and are dispensed therefrom as polyurethane foam. The tanks storing the resin component and the isocyanate component and the foam dispensing apparatus are pressurized to drive the resin and isocyanate components from the tanks and through the foam dispensing apparatus.

The tanks and the foam dispensing apparatus are pressurized by either a low pressure system or a high pressure system. The low pressure system uses gas pressure to pressurize the tanks and the foam dispensing apparatus. The low pressure system operates in a pressure range of 80 to 300 psi (pounds per square inch) and creates a flow rate of 0.25-10 gpm (gallons per minute) for each of the resin and isocyanate components, i.e., the low pressure system can dispense polyurethane foam at a flow rate of 0.5 to 20 pounds per minute. Because the low pressure system is pressurized by gas and operates at relatively low pressures, the low pressure system is relatively small and therefore relatively easy to transport and maneuver. In addition, the low pressure system is relatively inexpensive to manufacture. However, the flow rate of the polyurethane being dispensed from the foam dispensing apparatus is relatively low, which disadvantageously increases the amount of time to dispense a given amount of polyurethane foam.

The high pressure system operates in a pressure range of 850 to 6000 psi and creates a flow rate of each of the resin and isocyanate components of 4-50 gpm, i.e., the high pressure system can dispense polyurethane foam at 8-100 gpm. However, high pressure systems include large pumps and a large amount of relatively thick pipes. As a result, high pressure systems are disadvantageously large and therefore are difficult to transport and maneuver. In addition, high pressure systems are very expensive relative to low pressure systems.

Whether high or low pressure systems are utilized, once the chemicals exit the tanks, they are transported via a series of pipes or hoses and are dispensed through an apparatus such as a gun, or spray gun wherein they are combined and distributed onto a target surface, vessel or mold. At least one problem associated with existing systems is that they do not enable deposition of polyurethane foam on vertical surfaces in a satisfactory manner. Oftentimes, the dispensed foam lacks the inherent ability to hold on a vertical surface to produce a desirable finish, resulting instead in a sagging foam An additional problem with such systems is that they are frequently heavy, cumbersome and difficult to utilize in certain spaces due to size and configuration.

It would be advantageous to develop a foam dispensing device that dispenses polyurethane foam wherein the device, or system, permits enhanced control of various aspects of the dispensing process. Furthermore, it would be advantageous for such a device to be in a configuration that is easy to maneuver, and relatively inexpensive cost to manufacture and maintain.

### SUMMARY OF THE INVENTION

Provided herein is a foam dispensing apparatus for dispensing a mixture of a resin component and an isocyanate component, said foam dispensing apparatus comprising a heated hose assembly comprising a first hose consisting of a resin line for carrying the resin component from a pressurized tank and a second hose consisting of an isocyanate line for carrying the isocyanate component from a pressurized tank; a spray gun comprising a spray head and a mix tube; a nozzle for dispensing the resin and isocyanate components from the spray gun. The apparatus may further comprise at least one control valve controlling a flow rate of at least one of the resin component and the isocyanate component.

Also provided herein is a foam dispensing system for dispensing a mixture of a resin component and an isocyanate component, said foam dispensing system comprising: a source of resin component; a source of isocyanate component; a heated hose assembly comprising a first hose connected to the source of the resin component and consisting of a resin line for carrying the resin component; a second hose connected to the source of the isocyanate component and consisting of an isocyanate line for carrying the isocyanate component; a spray gun comprising a spray head and a mix tube; a nozzle for dispensing the resin and isocyanate components from the spray gun; wherein at least one valve connected to said resin and isocyanate lines and being moveable between an open position allowing flow through said resin and isocyanate lines and a closed position preventing flow through said resin and isocyanate lines.

Currently available polyurethane foam systems, including those designed for use in pour applications are typically sub-optimal as they require the use of a heavy gun and heavy hose assembly. Many such systems result in pour foam that lacks the inherent ability to hold on a vertical surface to produce a desirable finish, resulting instead in a sagging foam. The novel apparatus and systems claimed herein comprise the use of lightweight and low cost materials that enable overall greater utility. In one aspect, the apparatus and systems are available for use in a wider range of settings (compared to traditional spray foam systems), including settings having complex and hard to reach configurations. In another aspect, given the low cost of the components utilized, various parts can be easily replaced thereby improving the general functionality of the systems. In yet another aspect, the apparatus and systems enable the user to control many aspects of the process: valves for controlling the flow of the resin and/or isocyanate components, valves for controlling the flow into the spray gun, optional air assist mechanism for facilitating the flow of the resin and/or isocyanate components through the hoses and for facilitating the mixing of the components in the mix tube attached to the spray gun. The hoses may be heated, and this aspect is controlled via the use of a thermostat. As a consequence of these improvements, the resulting apparatus and systems are easy to use and enable the production of polyurethane foam having desirable characteristics such as lack of sagging in vertical applications, and greater precision in mold casting.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1A and 1B provide schematic views of a representative hose assembly. In embodiment depicted in FIGS. 1A and 1B, the 10 inch hose assembly comprises polyethylene tubing (3×8204, Tubing, Poly-Flo, ¼ “X 24”). The tubing is epoxied in place over an existing air line to give the assembly strength and durability. This addition allows a ball valve with bleed hole (3×8411) to be connected to assembly. This ball valve allows for better air flow to promote better chemical mix. FIG. 1A provides a view of spray gun and FIG. 1B provides a view of the hose assembly.

FIG. 2 provides a schematic view of ball valves utilized for hose connection.

FIG. 3 provides a schematic view of ball valves utilized for connecting hoses to pressurized tanks. As utilized herein, A side refers to the isocyanate tank, and B side refers to the resin side.

FIG. 4 is a schematic view of stainless steel hose.

FIG. 5 depicts the components of the heated hose: Nomex insulation, heat tape, pipe insulation, steel hose, and a thermostat.

FIG. 6 provides a depiction of the manner in which heat tape is wrapped around the steel hose;

FIGS. 7A and 7B show an embodiment where the hose bundle has two layers of insulation: the first layer comprises Nomex insulation (FIG. 7A), and the second comprises pipe insulation (FIG. 7B). In certain embodiments, the pipe insulation may comprise 1″×6′ Foam Rubber (Plumbing Tubular pipe insulation).

FIGS. 8A and 8B shows the outer covering (FIG. 8A), a black expandable sleeve (FIG. 8B), that covers the heated section of the hose bundle.

FIG. 9 provides an example of thermostat that can be used with the invention.

FIG. 10 shows tank connections that connect a hose to the isocyanate tank.

FIG. 11 shows tank connections that connect a hose to the resin side tank.

FIG. 12 provides a representative parts list for the disposable gun assembly according to the invention.

FIG. 13 provides a representative parts list for tank connections.

FIG. 14 provides a representative parts list for tank connections.

FIGS. 15A and 15B provide representative parts lists for ball valves associated with gun connections (FIG. 15A), and with tank connections (FIG. 15B).

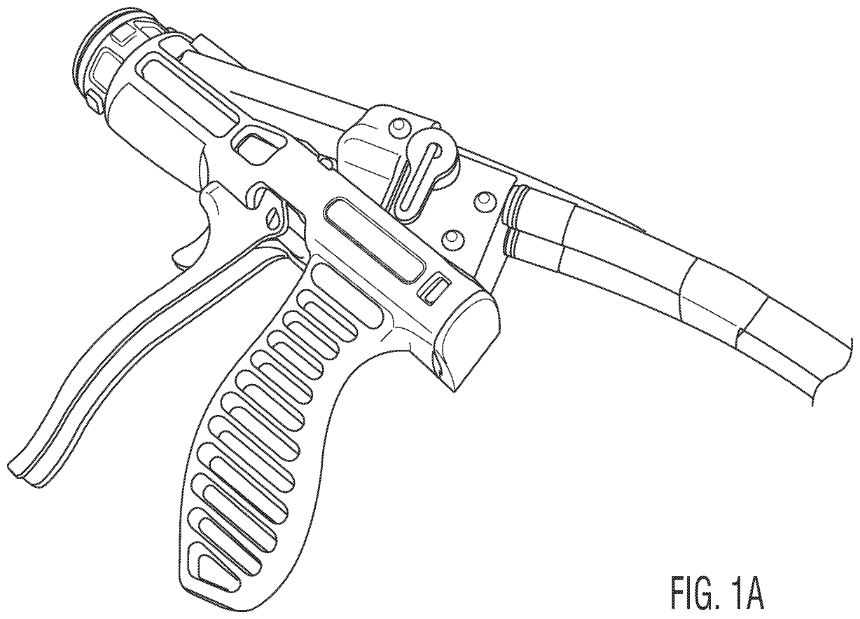

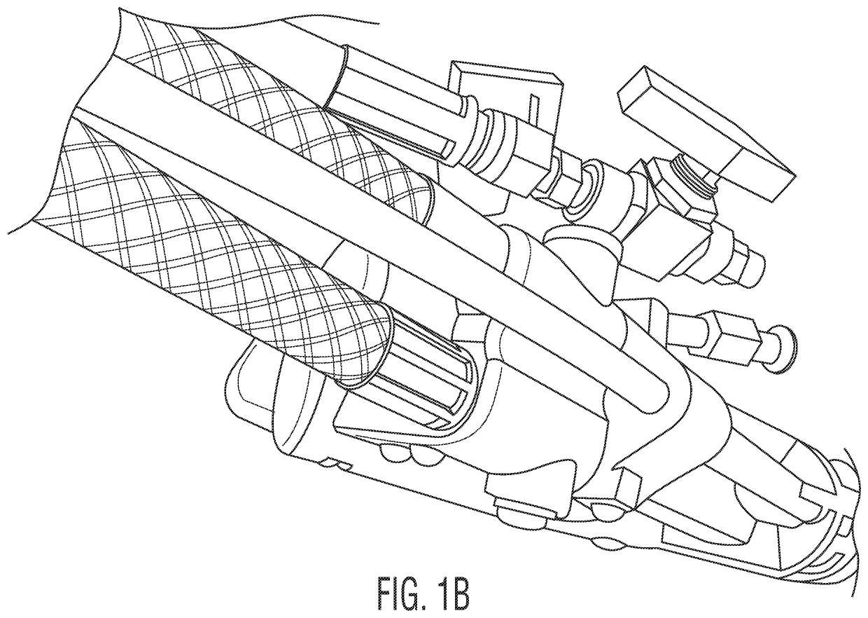

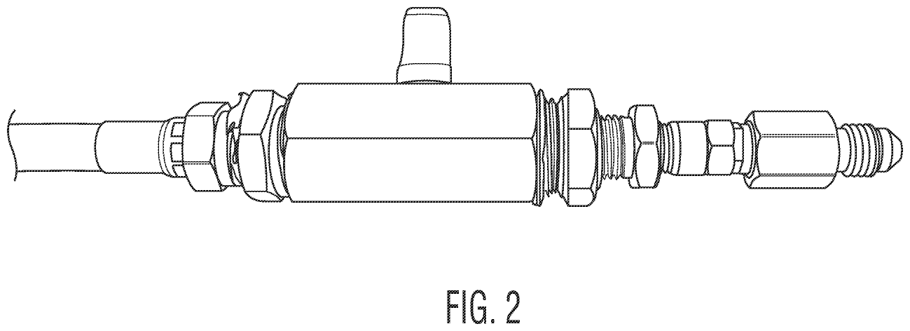

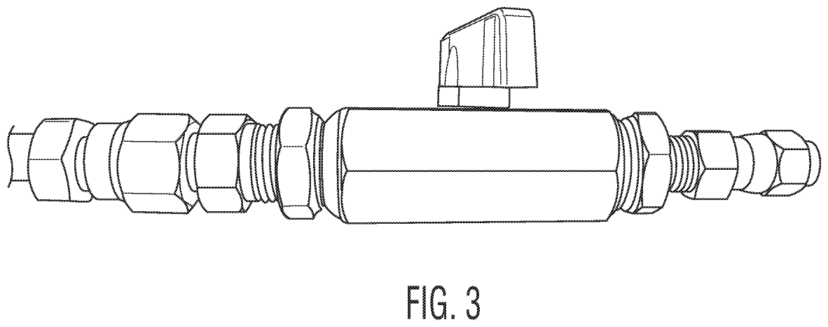

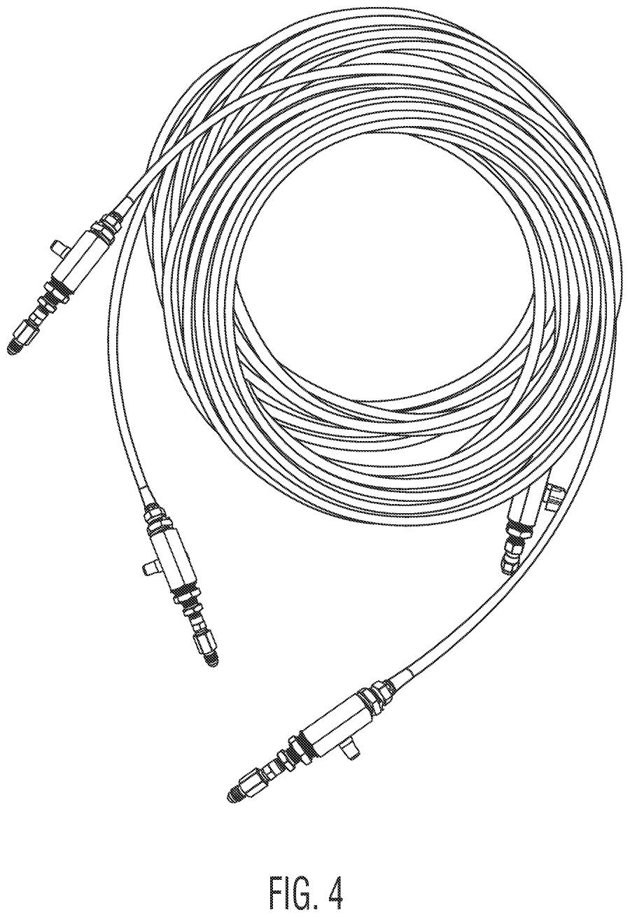

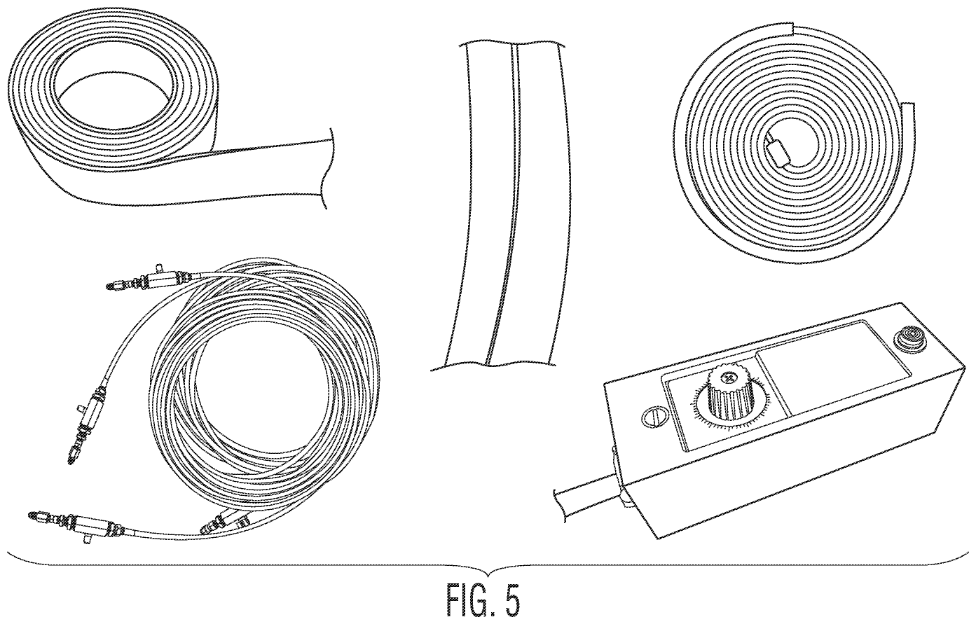

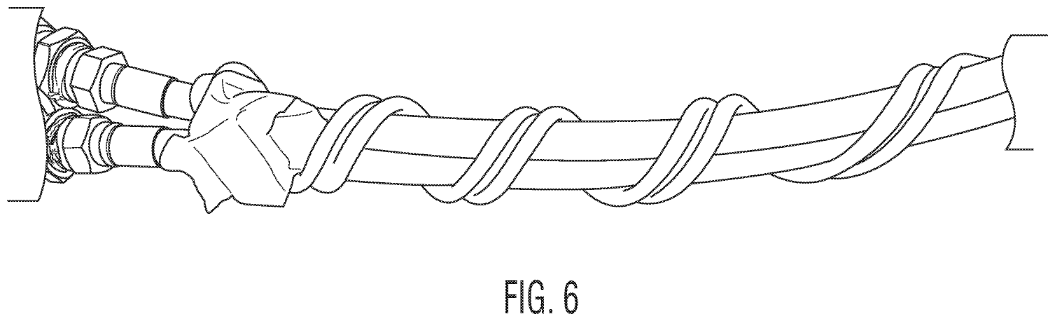

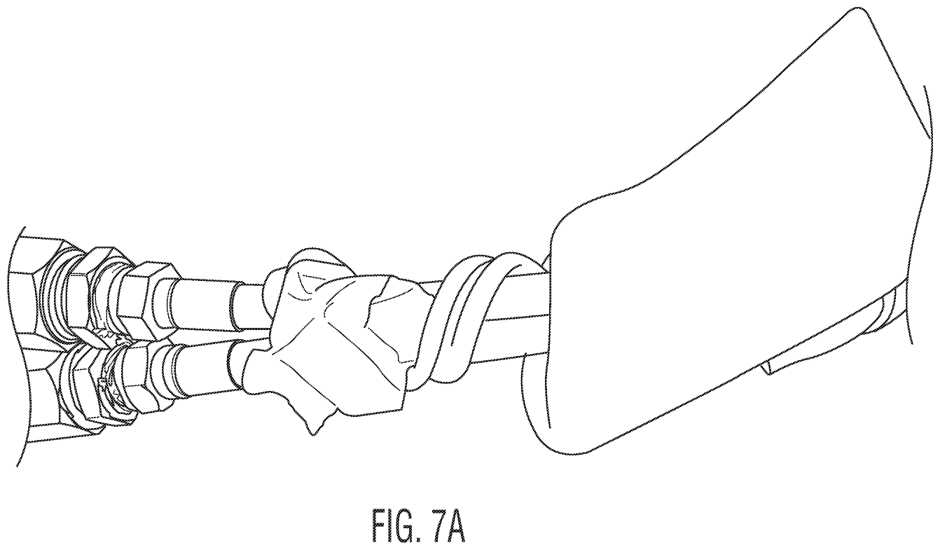

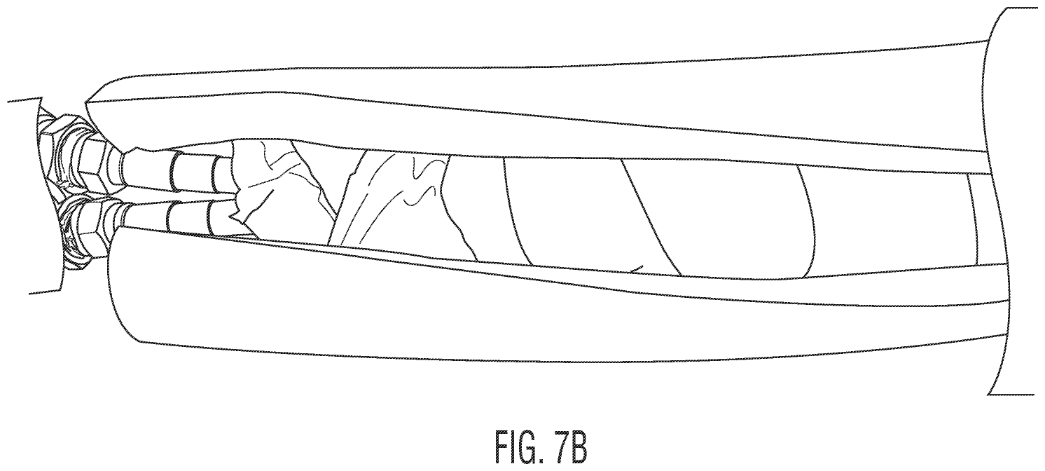

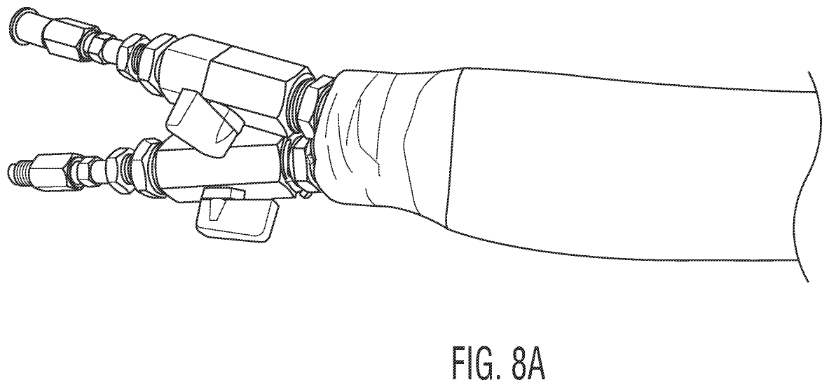

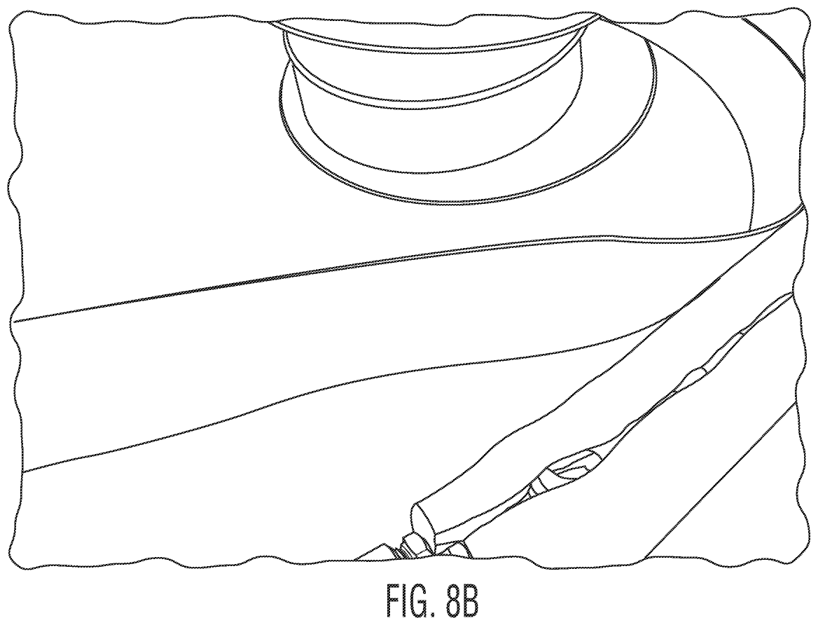

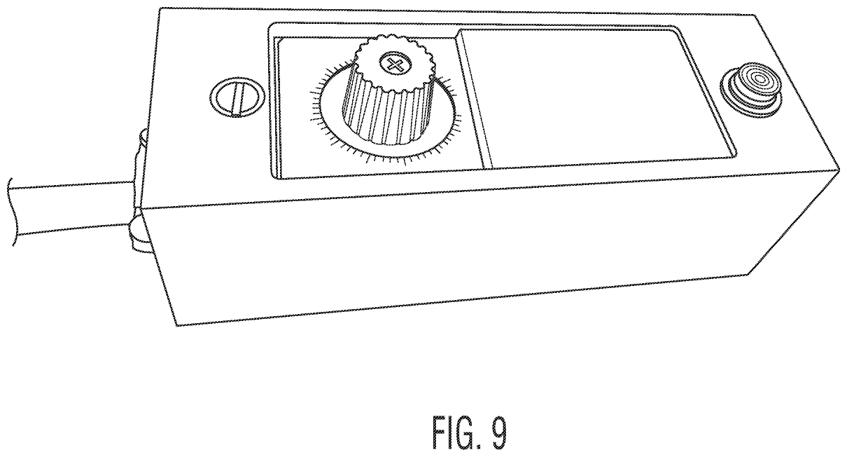

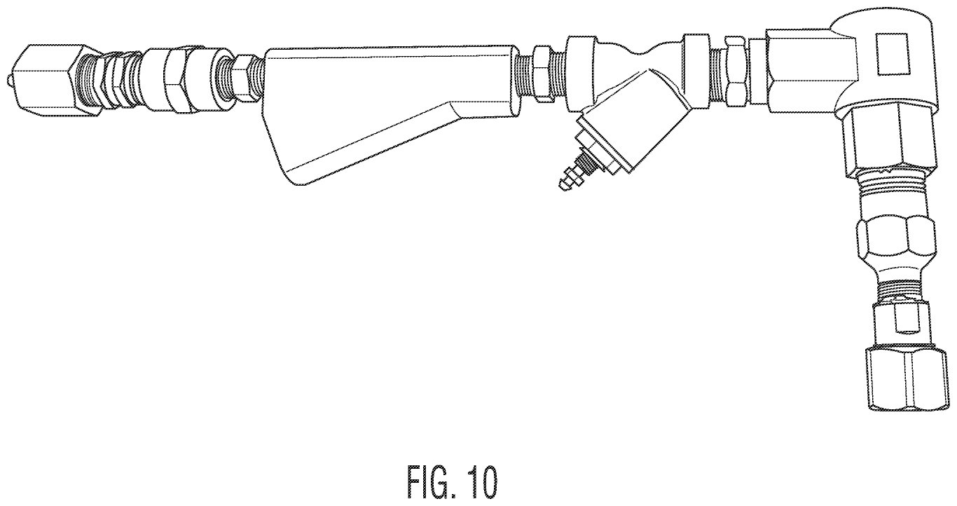

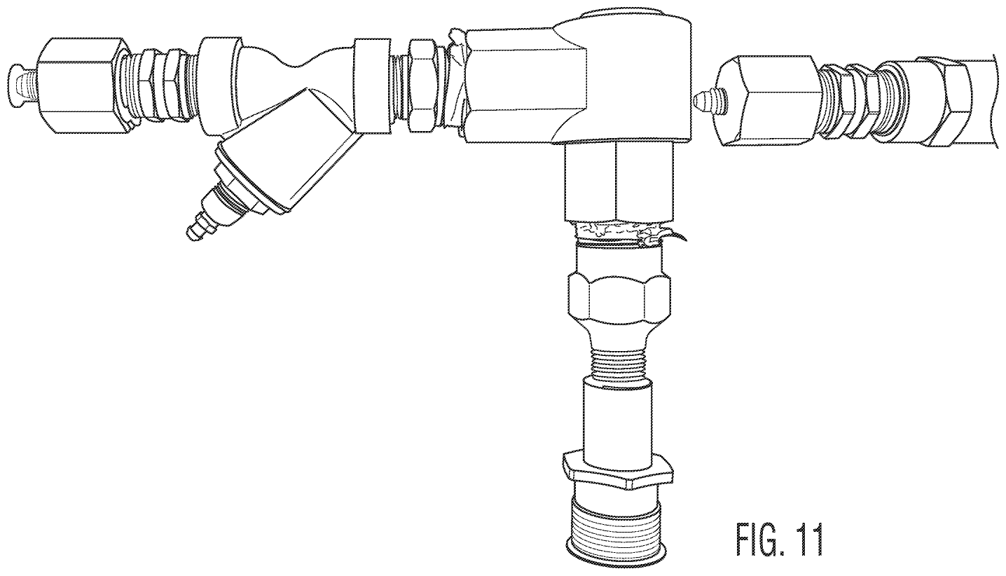

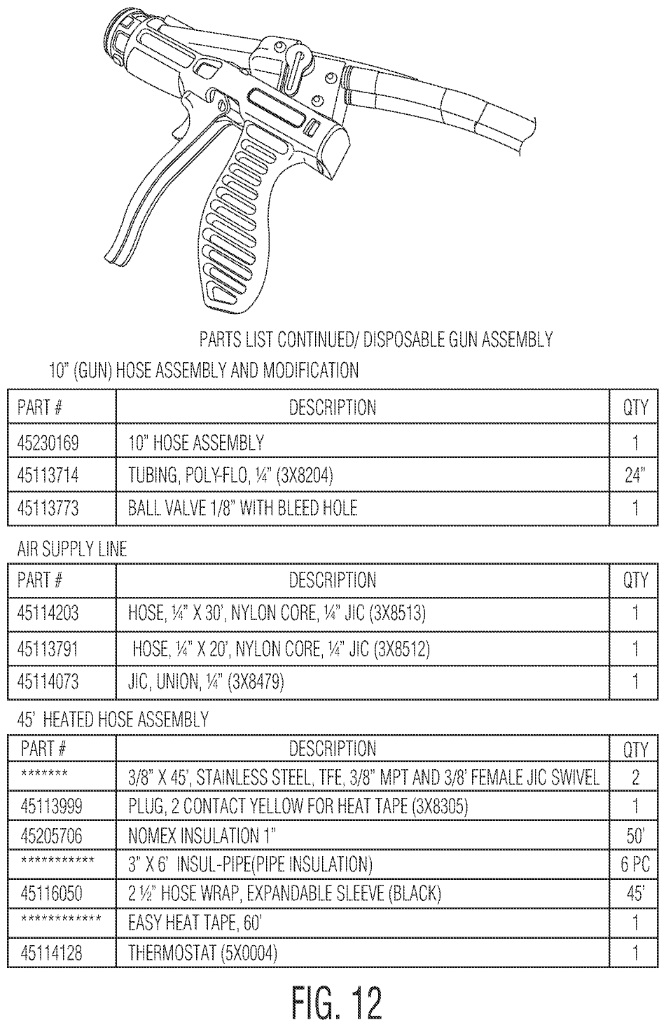

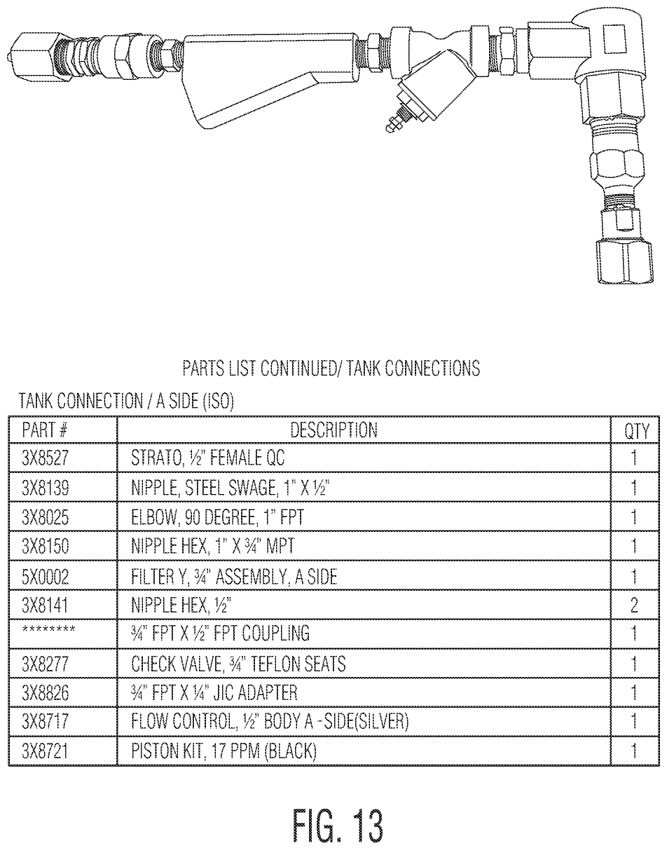

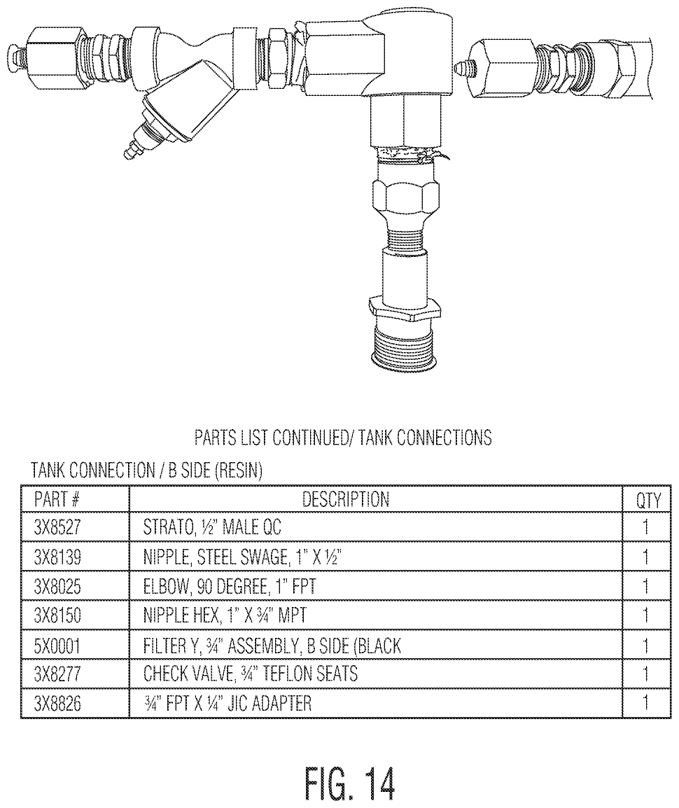

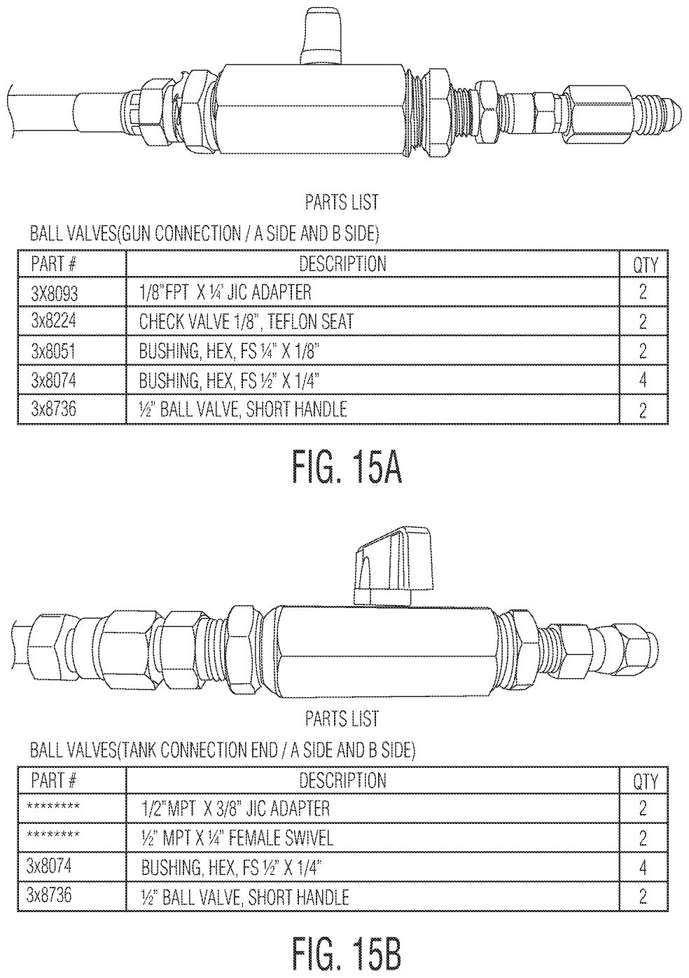

### DETAILED DESCRIPTION OF THE INVENTION

Provided herein are novel devices and device systems that enable the spraying or pouring of polyurethane. Prior systems are unwieldy, heavy and difficult to use in certain spaces; the current invention addresses these challenges by providing a spray gun that is constructed of lightweight material and is paired with a series of hoses, nozzles and other components that enable efficient mixing of polyurethane foam components and delivery thereof. Furthermore, the invention also comprises features that enable the heating of all or parts of the system, and also enables efficient vertical spray systems (without compromising the quality of the final finish). The device and systems disclosed herein are generally constructed of lightweight, low-cost material that result in overall low maintenance costs; indeed given total efficiency in material and production costs, many components, such as the gun, can be easily replaced without incurring any significant expense.

In general, the device and device systems claimed herein comprise a gun and hose assembly comprising a lightweight plastic gun and series of hoses and cylinders together with flow controllers and additional components. In certain embodiments the hoses are lightweight, flexible and constructed of rubber (optionally lined with high heat resistant material such as Teflon®). An important feature of the hoses and hose design is that they can be used in applications where the hose weight will not limit access into tight spaces and/or cause a safety issues with weight distribution. The circumference of the hoses may vary according to the purpose of the system, and in general can range from 0.25, 0.50, 0.75, 1.0, 1.25, 1.5, 1.75 to 2.0 inches. The hoses may be wrapped in a protective material, such as a heat or fire-resistant tape. The protective material may serve to protect the hoses from wear and tear and also to protect the hoses from temperature fluctuations and temperature extremes. In addition, the protective tape may prevent arcing. In certain embodiments, the hoses may be covered in a continuous wrap (such as a protective sleeve) in order to keep the hose assembly together, thereby further improving ease of use. In certain embodiments, the hose design combines aspects of insulation with quick heating that allows the chemical temperatures to be raised from below 70 degrees Fahrenheit to over 100 degrees Fahrenheit without using a heat exchanger or internally heated hoses. The hoses are connected to chemical tanks and flow controllers located at or near one or both of the tanks enable regulation of chemical flow. In an aspect, the flow controllers enable the production of resulting polyurethane foam having desired ratios of resin and isocyanate components. In certain aspects, the polyurethane foam is propelled by nitrogen gas (or similar inert gas). The resulting system comprises an easy to use assembly that allows for the proper mixing of polyurethane foam components (with or without air assist).

A significant advantage of the invention is that it can be used with industry standard (i.e. BASF) pour and spray systems. In an embodiment, the gun and hose design assembly allows for chemicals with up to 90 second string gel times to be used in a vertical spray application with desirable holding power. Accordingly, the same chemical system can be used for two very different application techniques in comparison to standard practice which is to use more than one set of equipment for pour foam and spray foam. This design therefore, allows the same foam system and gun to be used for both applications. In a further improvement over prior art systems, the current invention enables the maintenance of proper ratios and temperatures of the chemicals. In contrast, currently available dispensing systems do not include flow controllers that contribute to managing and stabilizing the ratios.

In an embodiment, the gun is made of light weight, recyclable, and/or low cost material. In certain aspects, following use, the gun may be easily replaced. In certain aspects, the gun may be created for single use. In certain embodiments, the gun has at least two settings that allow for high or low spray/pour. In certain embodiments, the gun has more than two settings that allow for precise control over spray/pour rates. The ability to control the speed of flow widens the practical use aspect of the gun and also increases the potential for application techniques.

In summary, the invention provided herein comprises a spray gun together with a set of hoses and other components that enables the spraying or pouring of polyurethane foam. In an embodiment, the spray gun comprises the ability to spray on a vertical surface a polyurethane foam system designed for use as a Coast Guard Approved pour foam system (approximately 90 second string gel time). The advantageous aspects of the system result from a combination of a light weight (and low cost) gun and hoses. The system is supplemented by a heating system that allows the contents of the hoses to reach a temperature above 100 degrees Fahrenheit without using a heat exchanger or internally heated hoses. The chemical flow in the hoses ranges from approximately 1 ppm to 5 ppm, or 1 ppm to 10 ppm, or 1 ppm to 20 ppm, and the chemical flow may be adjusted by the use of flow controllers, without adding weight to the gun head. In certain embodiments, the air assist mix is able to be set to a constant air flow or to increase the air flow depending on the actual mix requirements. In another aspect, a short mix tube after the chemical exits from the gun head allows for improved mixing. The ability to regulate flow, temperature and other parameters results in a unique amount of control over the system. For example, the same chemical spray system may be used as a pour foam system by simply lowering the hose heat down to 75-85 degrees Fahrenheit and adjusting the isocyanate chemical flow to match the maximum chemical flow on the resin side, followed by using the short mixer and the air assist to get the proper mix quality.

Provided herein are foam dispensing apparatuses and devices for dispensing a mixture of a resin component and an isocyanate component. In an embodiment, said foam dispensing apparatus comprises a heated hose assembly comprising; a first hose consisting of a resin line for carrying the resin component from a pressurized tank; a second hose consisting of an isocyanate line for carrying the isocyanate component from a pressurized tank; and a spray gun wherein a spray head comprises a mix tube and a nozzle for dispensing the resin and isocyanate components from the spray gun. In certain embodiments, the foam dispensing apparatus comprises features wherein the first and second hose are connected to their respective pressurized tanks via valves, wherein the apparatus further comprises an actuator coupled to said valve for moving said valve between said open and closed positions, and wherein said valve is further defined as a ball valve. In certain embodiments, the foam dispensing apparatus claimed herein further comprise at least one control valve controlling a flow rate of at least one of the resin component and the isocyanate component. In certain embodiments, the first and second hoses may be wrapped in protective material, they may be individually wrapped or they may be wrapped together to form a bundle. The protective material may be insulating material, heat resistant material or heat generating material. In some embodiments, the first and second hoses are lined with heat resistant material, wherein the heat resistant material may comprise Teflon®. The first and second hoses may lead to the spray gun through a second set of individual ball valves. In the spray gun, the resin component and an isocyanate component enter into the mix tube and become combined; and the combined mixture of the resin component and an isocyanate component results in a polyurethane which is then propelled out of the gun when the gun trigger is set in motion. The spray gun may further comprise an air assist mechanism, the air assist mechanism may further comprise a ball valve, and the air assist mechanism may enable the mixing of the resin component and an isocyanate component. In certain embodiments, the apparatus may also comprise a thermostat. The hoses and the spray gun may be constructed of lightweight material. Furthermore, other advantageous features comprise the construction of the hoses and the spray gun from inexpensive material. The spray gun optionally further comprises a secondary safety trigger. At least one unique feature of the invention is that the design of the hoses and the spray enables efficient vertical spraying. In certain embodiments, the resin line and said isocyanate line are pressurized to between 100 and 500 pounds per square inch, and the flow rate may be between 3 and 50 pounds per minute.

Provided herein are foam dispensing systems for dispensing a mixture of a resin component and an isocyanate component, wherein said foam dispensing systems comprise a source of resin component; a source of isocyanate component; connected to a first hose connected to the source of the resin component and consisting of a resin line for carrying the resin component; a second hose connected to the source of the isocyanate component and consisting of an isocyanate line for carrying the isocyanate component; a spray gun comprising a spray head and a mix tube; a nozzle for dispensing the resin and isocyanate components from the spray gun; wherein the first and second hose may be heated; at least one valve connected to said resin and isocyanate lines and being moveable between an open position allowing flow through said resin and isocyanate lines and a closed position preventing flow through said resin and isocyanate lines. The foam dispensing system may further comprise an actuator coupled to said valve for moving said valve between said open and closed positions. The foam dispensing system claimed herein may further comprise a source of compressed gas in communication with said sources of resin component and isocyanate component for pressurizing the resin and isocyanate components to move the resin and isocyanate components through the resin and isocyanate lines, respectively. The source of compressed gas may pressurize the sources of resin component and isocyanate component to between 100 and 500 pounds per square inch. In certain embodiments, the first and second hoses may be wrapped in protective material either individually wrapped or wrapped together to form a bundle. The protective material may be insulating material, heat resistant material or heat generating material. Furthermore, the first and/or second hoses may be lined with heat resistant material, wherein the heat resistant material may comprise Teflon®. The first and second hoses lead to the spray gun through a second set of individual ball valves, and the resin component and an isocyanate component enter into the mix tube and become combined in the spray gun. The combined mixture of the resin component and an isocyanate component results in a polyurethane which is then propelled out of the gun when the gun trigger is set in motion. In certain embodiments, the spray gun further comprises an air assist mechanism, and the air assist mechanism may further comprise a ball valve. Though not wishing to be bound by the following theory, it is expected that the air assist mechanism enables the mixing of the resin component and an isocyanate component. The foam dispensing system may optionally comprise a thermostat. In addition, the hoses and the spray gun may be constructed of lightweight material and/or inexpensive material. In certain embodiments, the spray gun further comprises a secondary safety trigger. An important aspect of the foaming system is that the novel design of the hoses and the spray enables efficient vertical spraying. Generally, the flow rate of the polyurethane spray is between 3 and 50 pounds per minute (and the rate can be adjusted according to the application). In certain specific embodiments, a 0.25 inch nylon hose attaches to the ball valve using a ¼′ JIC×¼″ male pipe thread (MPT) adapter. The hose is to connect into plant air to supply air to the gun head. It can be attached to hose bundle by using wire ties and runs the length of the heated hose. In certain embodiments, this attachment comprises the use of an approximately 20 foot section and an approximately 30 foot section of nylon hoses with the use of an approximately 0.25 inch JIC union″. The hose may be added via a quick connect or attached directly to the hose to plant air depending on the plants supply lines.

With respect to the polyurethane foam, the resin and isocyanate components are rapidly mixed together. A rapid cross-linking reaction and foam expansion commences, which ultimately yields the low density but relative high load bearing rigid polyurethane foam. The application of the polyurethane foam can, for example, be used for thermal insulation such as for appliances or buildings, marine floatation, coatings, and packaging. It is to be appreciated that the resin component and the isocyanate component can include foaming agents, curing agents, catalysts, accelerators, as well as other modifying additives. It is to be appreciated that in other applications, the first component, the second component, a tertiary component, and subsequent components may comprise other materials.

The isocyanate component may include, but is not limited to, isocyanates, diisocyanates, polyisocyanates, biurets of isocyanates and polyisocyanates, isocyanurates of isocyanates and polyisocyanates, and combinations thereof. In one embodiment, the isocyanate component includes an n-functional isocyanate. “n” may be a number from 2 to 5, from 2 to 4, or from 3 to 4. It is to be understood that n may be an integer or may have intermediate values from 2 to 5. The isocyanate component may include an isocyanate selected from the group of aromatic isocyanates, aliphatic isocyanates, and combinations thereof. In another embodiment, the isocyanate component includes an aliphatic isocyanate such as hexamethylene diisocyanate, H12MDI, and combinations thereof. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component may include an aromatic isocyanate. If the isocyanate component includes an aromatic isocyanate, the aromatic isocyanate may correspond to the formula R′(NCO)_{z} wherein R′ is aromatic and z is an integer that corresponds to the valence of R′. Preferably, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof.

The isocyanate component may have any % NCO content and any viscosity. The isocyanate component may also react with the resin and/or chain extender in any amount, as determined by one skilled in the art. Preferably, the isocyanate component and the resin and/or chain extender are reacted at an isocyanate index from 15 to 900, more preferably from 95 to 130, and alternatively from 105 to 130.

The resin component of the instant invention may include one or more of a polyether polyol, a polyester polyol, and combinations thereof. As is known in the art, polyether polyols are typically formed from a reaction of an initiator and an alkylene oxide. Preferably, the initiator is selected from the group of aliphatic initiators, aromatic initiators, and combinations thereof. In one embodiment, the initiator is selected from the group of ethylene glycol, propylene glycol, dipropylene glycol, butylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), thiodiglycol, glycerol, 1,1,1-trimethylolpropane, 1,1,1-trimethylolethane, 1,2,6-hexanetriol, α-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, triisopropanolamine, ethylenediamine, 1,3-diaminopropane, 1,3-diaminobutane, 1,4-diaminobutane, propylene diamine, butylene diamine, hexamethylene diamine, cyclohexalene diamine, phenylene diamine, tolylene diamine, xylylene diamine, 3,3′-dichlorobenzidine, 3,3′- and dinitrobenzidine, alkanol amines including ethanol amine, aminopropyl alcohol, 2,2-dimethyl propanol amine, 3-aminocyclohexyl alcohol, and p-aminobenzyl alcohol, and combinations thereof. It is contemplated that any suitable initiator known in the art may be used in the present invention.

Preferably, the alkylene oxide that reacts with the initiator to form the polyether polyol is selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. More preferably, the alkylene oxide is selected from the group of ethylene oxide, propylene oxide, and combinations thereof. Most preferably, the alkylene oxide includes ethylene oxide. However, it is also contemplated that any suitable alkylene oxide that is known in the art may be used in the present invention.

The polyether polyol may include an ethylene oxide cap of from 5 to 20% by weight based on the total weight of the polyether polyol. It is to be understood that the terminology “cap” refers to a terminal portion of the polyether polyol. Without intending to be bound by any particular theory, it is believed that the ethylene oxide cap promotes an increase in a rate of the reaction of the polyether polyol and the isocyanate.

The polyether polyol may also have a number average molecular weight of from 18 to 10,000 g/mol. Further, the polyether polyol may have a hydroxyl number of from 15 to 6,250 mg KOH/g. The polyether polyol may also have a nominal functionality of from 2 to 8. Further, further, the polyether polyol may also include an organic functional group selected from the group of a carboxyl group, an amine group, a carbamate group, an amide group, and an epoxy group.

Referring now to the polyester polyols introduced above, the polyester polyols may be produced from a reaction of a dicarboxylic acid and a glycol having at least one primary hydroxyl group. Suitable dicarboxylic acids may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Suitable glycols include, but are not limited to, those described above.

The polyester polyol may also have a number average molecular weight of from 80 to 1500 g/mol. Further, the polyester polyol may have a hydroxyl number of from 40 to 600 mg KOH/g. The polyester polyol may also have a nominal functionality of from 2 to 8. Further, further, the polyester polyol may also include an organic functional group selected from the group of a carboxyl group, an amine group, a carbamate group, an amide group, and an epoxy group.

It is to be appreciated that the resin component can include additives. The additives may be selected from the group of chain extenders, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, thixotropic agents, silicones, transition metals, catalysts, blowing agents, surfactants, cross-linkers, inert diluents, and combinations thereof. The additives may be included in any amount as desired by those of skill in the art.

The foam dispensing system includes a foam dispensing apparatus, the spray gun, connected to a source of resin component and a source of isocyanate component. The spray gun combines the resin component and the isocyanate component and sprays the mixture as set forth above. The foam dispensing apparatus conveniently light weight so as to be easily carried and maneuvered by a user so that the mixture can be sprayed in selected locations, various configurations and directions.

The source of resin component and the source of isocyanate component are each typically a pressurized cylinder that stores the resin and isocyanate components, respectively. It is to be appreciated that the sources of resin and isocyanate components can be any type of pressurized tank without departing from the nature of the present invention. In any event, the sources of resin and isocyanate components maintain the resin and the isocyanate components separated from each other.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1: A foam dispensing apparatus for dispensing a mixture of a resin component and an isocyanate component, said foam dispensing apparatus comprising:
a) a heated hose assembly comprising:
i. a first hose consisting of a resin line for carrying the resin component from a first pressurized tank;
ii. a second hose consisting of an isocyanate line for carrying the isocyanate component from a second pressurized tank; and
b) a spray gun wherein a spray head comprises a mix tube and a nozzle for dispensing the resin component and the isocyanate component from the spray gun.

2: The foam dispensing apparatus as set forth in claim 1, wherein the first hose and the second hose are each connected to the first pressurized tank and the second pressurized tank, respectively, via a valve.

3: The foam dispensing apparatus as set forth in claim 2, further comprising an actuator coupled to said valve for moving said valve between open and closed positions.

4: The foam dispensing apparatus as set forth in claim 3, wherein said valve is a ball valve.

5: The foam dispensing apparatus as set forth in claim 3, further comprising at least one control valve controlling a flow rate of at least one of the resin component and the isocyanate component.

6: The foam dispensing apparatus as set forth in claim 1, wherein the first hose and the second hose are wrapped in protective material.

7: The foam dispensing apparatus as set forth in claim 6, wherein the first hose and the second hose are individually wrapped or wrapped together to form a bundle.

8: The foam dispensing apparatus as set forth in claim 7, wherein the protective material is insulating material, heat resistant material, or heat generating material.

9: The foam dispensing apparatus as set forth in claim 1, wherein the first hose and the second hose are lined with heat resistant material.

10: The foam dispensing apparatus as set forth in claim 9, wherein the heat resistant material comprises a high heat resistant material.

11: The foam dispensing apparatus as set forth in claim 8, wherein the first hose and the second hose lead to the spray gun through a second set of individual ball valves.

12: The foam dispensing apparatus as set forth in claim 11, wherein the resin component and the isocyanate component enter into the mix tube and become combined.

13: The foam dispensing apparatus as set forth in claim 12, wherein a combined mixture of the resin component and the isocyanate component results in a polyurethane which is then propelled out of the spray can when a gun trigger is set in motion.

14: The foam dispensing apparatus as set forth in claim 1, further comprising an air assist mechanism.

15: The foam dispensing apparatus as set forth in claim 14, wherein the air assist mechanism further comprises a ball valve.

16: The foam dispensing apparatus as set forth in claim 14, wherein the air assist mechanism enables mixing of the resin component and the isocyanate component.

17: The foam dispensing apparatus as set forth in claim 1, further comprising a thermostat.

18: The foam dispensing apparatus as set forth in claim 1, wherein the first hose, the second hose, and the spray gun are constructed of lightweight material.

19: The foam dispensing apparatus as set forth in claim 1, wherein the first hose, the second hose, and the spray gun are constructed of inexpensive material.

20: The foam dispensing apparatus as set forth in claim 1, wherein the spray gun further comprises a secondary safety trigger.

21: The foam dispensing apparatus as set forth in claim 1, wherein a design of the first hose, the second hose, and the spray gun enables efficient vertical spraying.

22: The foam dispensing apparatus as set forth in claim 1, wherein said resin line and said isocyanate line are pressurized to between 80 and 300 pounds per square inch.

23: The foam dispensing apparatus as set forth in claim 5, wherein said flow rate is between 3 and 50 pounds per minute.

24: A foam dispensing system for dispensing a mixture of a resin component and an isocyanate component, said foam dispensing system comprising:
a source of resin component;
a source of isocyanate component;
a first hose connected to the source of the resin component and consisting of a resin line for carrying the resin component;
a second hose connected to the source of the isocyanate component and consisting of an isocyanate line for carrying the isocyanate component;
a spray gun comprising a spray head and a mix tube;
a nozzle for dispensing the resin component and the isocyanate component from the spray gun; and
at least one valve connected to said resin line and said isocyanate line, and moveable between an open position allowing flow through said resin line and said isocyanate line and a closed position preventing flow through said resin line and said isocyanate line;
wherein the first hose and second hose are configured for heating.

25: The foam dispensing system as set forth in claim 24, further comprising an actuator coupled to said at least one valve, for moving said at least one valve between said open position and closed position.

26: The foam dispensing system as set forth in claim 24, further comprising a source of compressed gas in communication with the source of the of resin component and the source of the isocyanate component for pressurizing the resin component and the isocyanate component to move the resin component and the isocyanate component through the resin line and the isocyanate line, respectively.

27: The foam dispensing system as set forth in claim 26, wherein said source of compressed gas pressurizes the source of the resin component and the source of the isocyanate component to between 100 and 500 pounds per square inch.

28: The foam dispensing system as set forth in claim 24, wherein the first hose and the second hose are wrapped in protective material.

29: The foam dispensing system as set forth in claim 24, wherein the first hose and the second hose are individually wrapped or wrapped together to form a bundle.

30: The foam dispensing system as set forth in claim 28, wherein the protective material is insulating material, heat resistant material, or heat generating material.

31: The foam dispensing system as set forth in claim 24, wherein the first hose and the second hose are lined with heat resistant material.

32: The foam dispensing system as set forth in claim 31, wherein the heat resistant material comprises a high heat resistant material.

33: The foam dispensing system as set forth in claim 24, wherein the first hose and the second hose lead to the spray gun through a second set of individual ball valves.

34: The foam dispensing system as set forth in claim 24, wherein the resin component and the isocyanate component enter into the mix tube and become combined.

35: The foam dispensing system as set forth in claim 34, wherein a combined mixture of the resin component and the isocyanate component results in a polyurethane which is then propelled out of the spray gun when a gun trigger is set in motion.

36: The foam dispensing system as set forth in claim 24, further comprising an air assist mechanism.

37: The foam dispensing system as set forth in claim 36, wherein the air assist mechanism further comprises a ball valve.

38: The foam dispensing system as set forth in claim 37, wherein the air assist mechanism enables mixing of the resin component and the isocyanate component.

39: The foam dispensing system as set forth in claim 24, further comprising a thermostat.

40: The foam dispensing system as set forth in claim 24, wherein the first hose, the second hose, and the spray gun are constructed of lightweight material.

41: The foam dispensing system as set forth in claim 24, wherein the first hose, the second hose, and the spray gun are constructed of inexpensive material.

42: The foam dispensing system as set forth in claim 24, wherein the spray gun further comprises a secondary safety trigger.

43: The foam system as set forth in claim 24, wherein a design of the first hose, the second hose, and the spray gun, enables efficient vertical spraying.

44: The foam system as set forth in claim 24, wherein a flow rate is between 5 and 70 gallons per minute.

45: The foam system as set forth in claim 37, wherein a ¼″ nylon hose is attached to the ball valve with a ¼′ Joint Industry Council (JIC) union x ¼″ male pipe thread (MPT) adapter.

46: The foam system as set forth in claim 45, wherein the ¼″ nylon hose connects into plant air to supply air to the spray head.

47: The foam system as set forth in claim 46, wherein the nylon hose is connected to a hose bundle comprising the first hose and the second hose, with wire ties and runs a length of the first hose and second hose.

48: The foam system as set forth in claim 47, wherein the nylon hose attached to the ball valve is a 20′ section or a 30′ section of nylon hose.
